(19) United States
(12) Patent Application Publication
(10) Pub. No.: US 2005/0284025 A1
(43) Pub. Date: Dec. 29, 2005

(54) Upper articulation assembly for windows and doors with wing and swivel wing opening

(75) Inventor: Aimone Balbo Di Vinadio, Torino (IT)

Correspondence Address: HESLIN ROTHENBERG FARLEY & MESITI PC, 5 COLUMBIA CIRCLE, ALBANY, NY, 12203, US

(73) Assignee: SAVIO S.p.A., Chiusa San Michele (Torino) (IT)

(21) Appl. No.: 11/158,091

(22) Filed: Jun. 21, 2005

(30) Foreign Application Priority Data
Jun. 28, 2004 (IT) TO 2004 A 000439

(51) Int. Cl. E05D 15/28

(52) U.S. Cl. 49/246

(57) ABSTRACT

An upper articulation device for windows and doors openable with swivel wing which include a fixed frame and a movable frame, comprising: an articulation device including a support element to be fastened to the fixed frame, a guiding element to be fastened to the movable frame and provided with a guiding groove and with an articulation seat, an arm having a first end connected in articulated fashion to said support element of the articulation device and a second end slidably articulated in said guiding groove, and a scissors lever having a first end articulated to the arm and a second end articulated around a fixed axis in said articulation seat of the guiding element. The second end of the scissors lever bears an articulation pivot pin which engages in snap-on fashion the articulation seat of the guiding element.

### TEXT OF THE DESCRIPTION

The present invention relates to an upper articulation assembly for windows and doors with wing and swivel wing opening. Windows and doors of this type comprise a movable frame which can be opened by means of a rotation around a vertical axis (wing opening) or by rotation around a lower horizontal axis (swivel wing opening).

The upper articulation assembly for a window or door openable with swivel wing comprises a hinging device which is fastened to the fixed frame and which bears an arm with a scissors lever connected in articulated fashion to a guiding element fastened to an upper cross member of the movable frame.

In traditional solutions, the arm and the scissors lever are permanently connected to the guiding element, to be fastened to the movable frame. The arm is also permanently connected to the hinging device which is to be fastened to the fixed frame. Therefore, during the mounting of the window or door, the installer normally fastens the guiding element to the upper cross member of the movable frame and then connects the hinging device to the fixed frame. This mounting procedure is difficult when using “disappearing” articulation assemblies which are invisible from the outside when the movable frame is in closed position. The hinging device of disappearing articulation assemblies is fastened to the fixed frame in a position that is hard to access when the movable frame is already partially mounted.

The object of the present invention is to provide an upper articulation assembly of the disappearing type which allows to simplify the operation of mounting the window or door.

According to the present invention, said object is achieved by an articulation assembly having the characteristics set out in the claims.

The present invention shall now be described in detail with reference to the accompanying drawings, provided purely by way of non limiting example, in which:

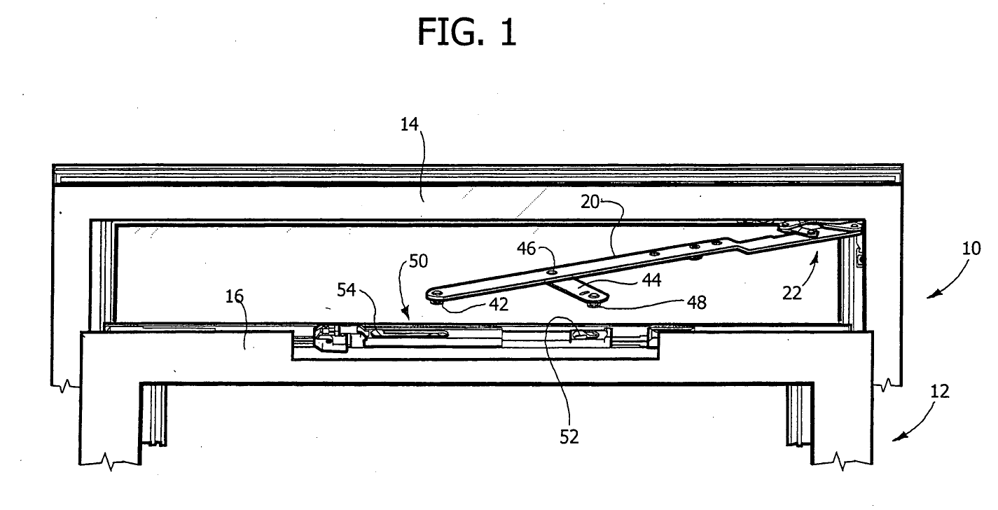

FIG. 1 is a front view of an articulation assembly according to the present invention during the mounting of a window or door,

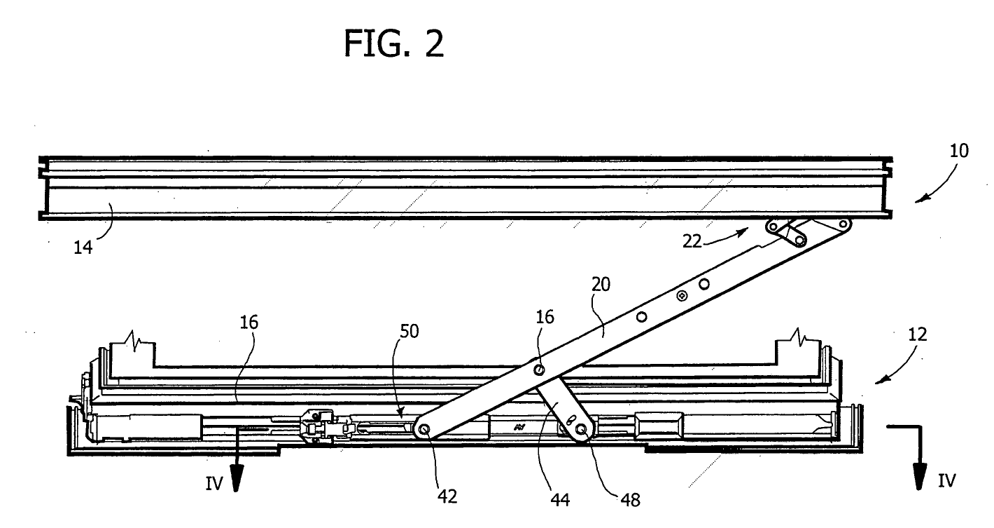

FIG. 2 is a plan view showing the articulation assembly of FIG. 1 in the mounted configuration and with the movable frame open in swivel wing fashion,

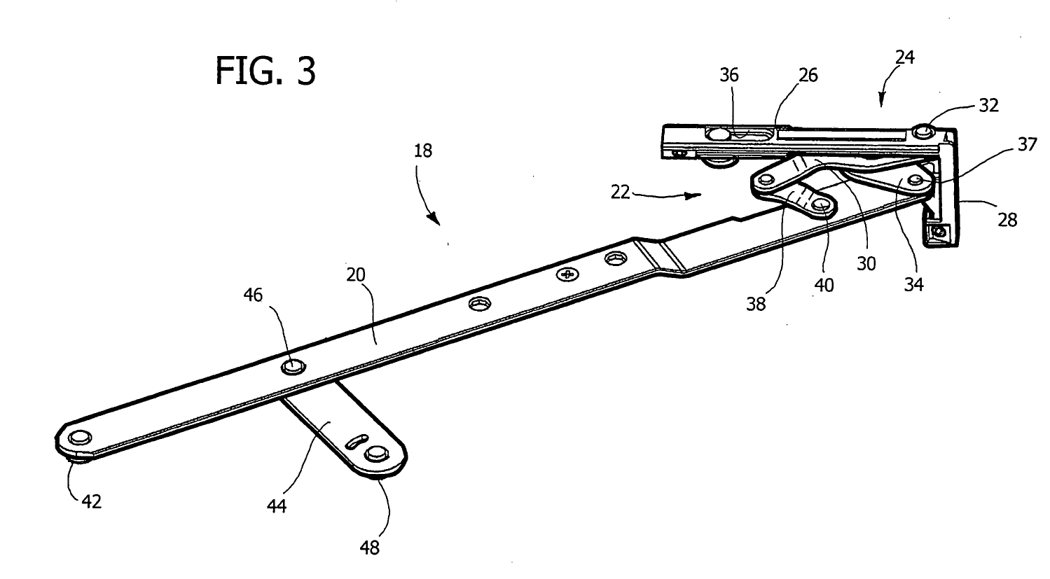

FIG. 3 is a perspective view of the articulation assembly according to the invention,

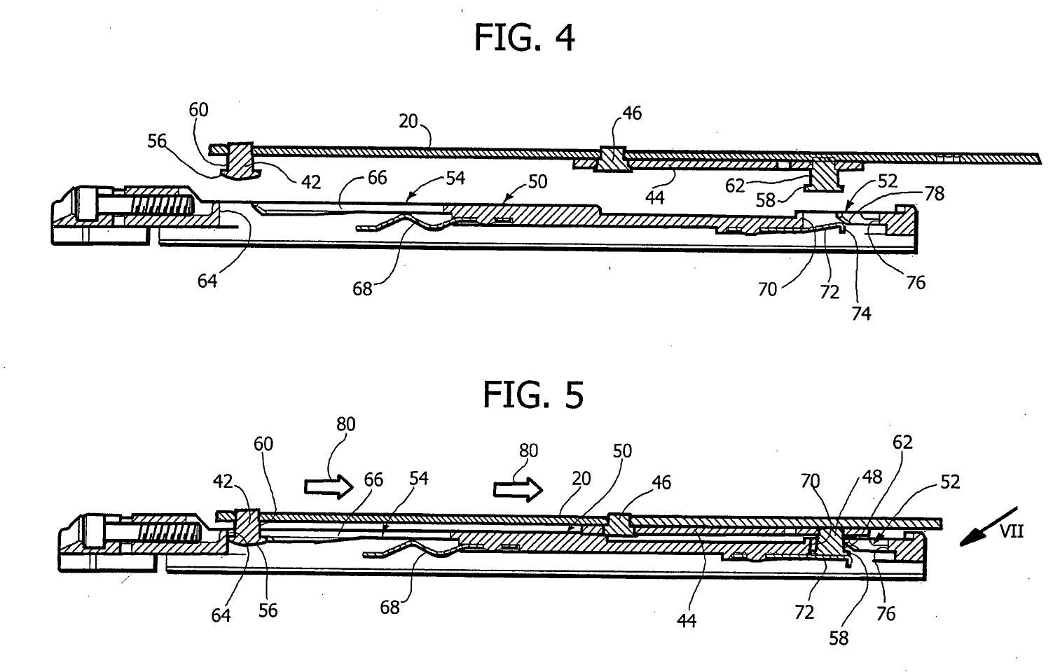

FIGS. 4, 5 and 6 are sections according to the line IV-IV of FIG. 2 illustrating the mounting sequences of the articulation assembly according to the invention,

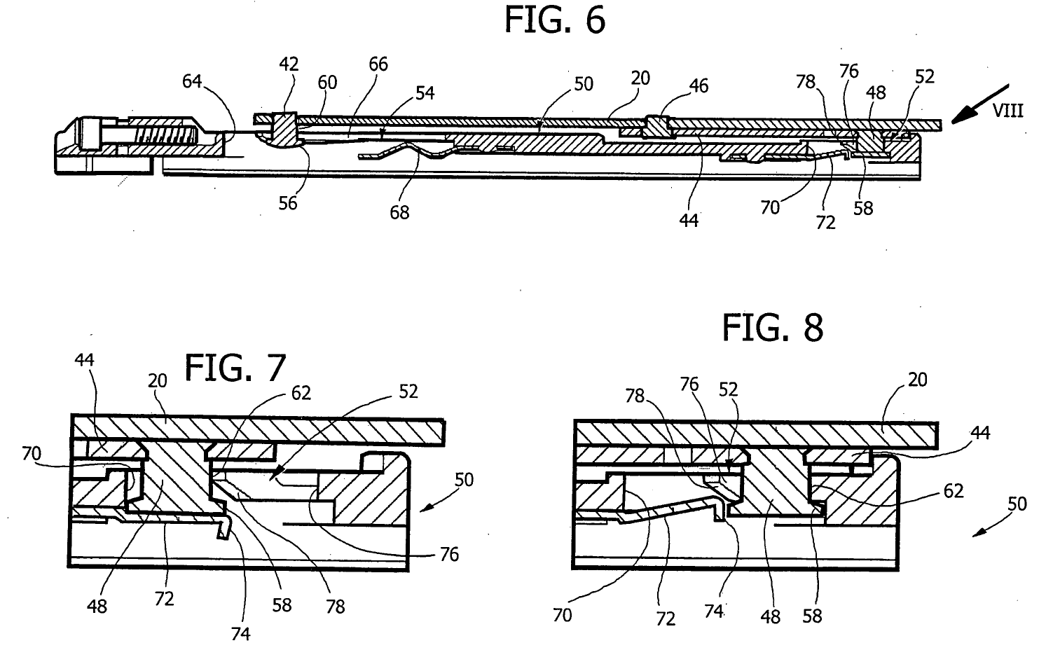

FIGS. 7 and 8 are details in enlarged scale of the parts indicated by the arrows VII and VIII in FIGS. 5 and 6.

FIGS. 1 and 4 show the upper part of a window, French window or the like comprising a fixed frame 10 and a movable frame 12. The movable frame is provided with a swivel wing opening movement. The mechanisms that allow selectively to obtain the swivel wing opening motion of the movable frame 12 are known in themselves and are not described in detail herein because they are outside the scope of the present invention. The fixed frame 10 and the movable frame 12 are provided with respective upper cross members 14, 16 which in the swivel wing opening position are mutually distanced and parallel.

With reference to FIG. 3, the reference number 18 designates an articulation assembly according to the present invention, comprising an arm 20 connected in articulated fashion to an articulation device 22. The articulation device 22 comprises a support element 24 to be fastened to the fixed frame 10. The support element 24 is preferably constituted by a monolithic element of die cast material with a general “L” shape with a horizontal branch 26 which is fastened to the cross member 14 and a vertical branch 28 which is fastened to the upper part of the upright of the fixed frame 10.

The articulation device 22 comprises a main lever 30 articulated to the support element 24 around a first axis 32 and a secondary lever 34 articulated to the main lever 30 around a second axis, parallel to the main axis 32. The secondary lever 34 has a first end which is articulated in slidable fashion in a guiding groove 36 formed on the horizontal branch 26 of the support element 24. A second end of the second lever 34 is articulated to the arm 20 around a third axis 37 parallel to the main axis 32. The main lever 30 has an end articulated to a connecting rod 38 which in turn is articulated to the arm 20 around a fourth axis 40 which is also parallel to the main axis 32.

The articulation device 22 achieves an articulation of the disappearing type of the movable frame 12 relative to the fixed frame 10. In the closed position of the movable frame 12, the articulation device 22 is contained in the free space between the upper cross members 14, 16 close to each other, and is not visible from the exterior. The articulation device 22 allows an oscillating movement of the arm 20 between a closed position in which the arm 20 is parallel to the upper cross member 14 of the fixed frame 10 and an open position in which the arm 20 is rotated in a horizontal plane relative to the closed position.

With reference again to FIG. 3, the arm 20 at the opposite end relative to the articulation device 22 bears a pivot pin 42 for connection to the movable frame 12. The arm 20 also bears a scissors lever 44 articulated to the arm 20 around an axis 46 distanced from the pivot pin 42 located at the end of the arm. The scissors lever 44 bears at its distal end a second articulation pivot pin 48 for connection to the movable frame 12.

With reference to FIGS. 1 and 2, the two articulating pivot pins 42, 48 of the arm 20 and of the scissors lever 44 are connected to a guiding element 50 fastened to the upper cross member 16 of the movable frame 12.

The articulating pivot pin 48 of the scissors lever 44 is articulated around a fixed axis in a seat 52 of the guiding element 50. The pivot pin 42 of the arm 20 is slidably articulated in an elongated groove 54 of the guiding element 50.

The guiding element 54 is associated to a blocking device, known in itself (not shown) which can selectively block and unlock the sliding movement of the pivot pin 42 along the groove 54. When the sliding movement of the pivot pin 42 is blocked, the movable frame 12 can be opened in wing fashion. When the pivot pin 42 is free to slide along the groove 54, the movable frame 12 can be open in swivel wing fashion.

The arm 20 is articulated in permanent and non removable fashion to the articulation device 22 and it is disengaged from the guiding element 50 before the final mounting of the movable frame 12 on the fixed frame 10. Therefore, the mounting procedure provides for fastening the guiding element 50 to the fixed frame 12 and, on the other side, to fasten the support element 24 of the articulation device 22 to the fixed frame 10 while the arm 20 is disengaged from the guiding element 50. This considerably facilitates the fastening of the articulation device 22 to the frame 10 because the mounting can be performed in considerably simpler fashion relative to the condition in which the arm 20 is permanently connected to the guiding element 50 and to the movable frame 12. Subsequently, the arm 20 and the scissors lever 44 are connected to the guiding element 50 in the manner shown in FIGS. 4 through 8.

With reference to FIGS. 4 through 8, the pivot pins 42 and 48 both have a broadened head 56 and 58, distal relative to the arm 20 and to the scissors lever 44 and a cylindrical stem 60, 62 with a smaller diameter than the diameter of the head 56, 58. The guiding groove 54 has an insertion portion 64 with a greater diameter than the diameter of the head 56 and a sliding portion 66 with a smaller width than the diameter of the head 56. At the end of the groove 54 opposite to the insertion portion 64 is positioned an elastic stop element 68 able to retain in stable position the pivot pin 42 in the position corresponding to the wing opening configuration.

The articulation seat 52 comprises an insertion portion 70 whose diameter is greater than the diameter of the head 58 of the pivot pin 48. Underneath the insertion portion 70 is provided an elastic element 72 fastened to the guiding element 50 and having a blocking surface 74. The seat 52 also has an articulation region 76 with smaller diameter than the diameter of the head 58. There is also an inclined inviting bevel 78 that facilitates the entry of the pivot pin 48 into the articulation region 76.

The connection of the pivot pin 42, 48 to the guiding element 50 is executed according to the sequence illustrated in FIGS. 4, 5 and 6. In the first step shown in FIG. 4, the pivot pins 42 and 48 are positioned at the respective insertion regions 64 and 70. Then, as shown in FIG. 5, the pivot pins 42 and 48 are inserted into the insertion portions 64 and 70. During the insertion of the pivot pin 48 into the insertion portion 70 the elastic element 72 is deformed elastically downwards. Then, the pivot pins 42 and 48 are thrust into the direction indicated by the arrows 80 in FIG. 5. As a result of this movement, the pivot pins 42, 48 move to the position shown in FIG. 8. In this configuration, the pivot pin 48 engages the articulation region 76 of the seat 52. The elastic element 72 returns to the undeformed position as soon as the pivot pin 48 enters the articulation region 76 of the seat 52 and, in this position, the locking surface 74 of the elastic element 72 prevents the pivot pin 48 from returning to the insertion region 70. The pivot pin 48 is thus engaged in freely rotatable fashion around an axis, fixed with respect to the articulation region 76 of the seat 52.

The pivot pin 42 slidably engages the sliding portion 66 of the groove 54 and cannot reach the insertion region 64, being retained by the pivot pin 48.

The pivot pin 48 achieves a snap-in engagement with the seat 52 of the guiding element 50.

The operator who executes the installation of the window or door can then connect the arm 20 and the scissors lever 44 to the guiding element 50 (previously fastened to the movable frame 12) in simple, rapid fashion and without having to use mounting tools. As indicated above, the operator is thus free to mount the articulation device 22 to the fixed frame 10 while the arm 20 and the scissors lever 44 are disengaged from the guiding element 50, in such a way as to be able to access the fastening region of the articulation device 22 without the bulk of the movable frame 12.

Naturally, without altering the principle of the invention, the construction details and the embodiments may be widely varied from what is described and illustrated herein without thereby departing from the scope of the invention as defined by the claims that follow.

1. An upper articulation device for windows and doors with wing and swivel wing opening which include a fixed frame and a movable frame, comprising:
an articulation device including a support element (24) to be fastened to the fixed frame,
a guiding element to be fastened to the movable frame and provided with a guiding groove and with an articulation seat,
an arm having a first end connected in articulated fashion to said support element of the articulation device and a second end slidably articulated in said guiding groove,
a scissors lever having a first end articulated to the arm and a second end articulated around a fixed axis in said articulation seat of the guiding element, wherein the second end of said scissors lever bears an articulation pivot pin which engages in snap-on fashion said articulation seat of the guiding element.

2. Articulation assembly as claimed in claim 1, wherein the articulation pivot pin of the scissors lever has a broadened head distal with respect to the scissors lever and a stem whose diameter is smaller than the diameter of the head, and wherein said articulation seat has an insertion portion whose diameter is larger than the diameter of the head and an articulation portion whose diameter is smaller than the diameter of the head.

3. Articulation assembly as claimed in claim 2, wherein the articulation seat comprises an elastic element positioned at the insertion portion and provided with a locking surface able to secure the pivot pin in the articulation portion.

4. Articulation assembly as claimed in claim 1, wherein the arm bears at its distal end an articulation pivot pin having a broadened head and a stem whose diameter is smaller than the diameter of the head, and in that the guiding groove of the guiding element is provided with an insertion portion whose diameter is greater than the diameter of the broadened head of the pivot pin and a sliding portion whose width is smaller than the diameter of the broadened head of the pivot pin.
